(19) United States
(12) Patent Application Publication
(10) Pub. No.: US 2026/0027530 A1
(43) Pub. Date: Jan. 29, 2026

(54) INTERNAL GAS DISTRIBUTOR FOR A CONTAINER

(71) Applicant: Dean Potter, Wichita, KS (US)

(72) Inventor: Dean Potter, Wichita, KS (US)

(21) Appl. No.: 18/783,447

(22) Filed: Jul. 25, 2024

(51) Int. Cl. B01F 25/431; B01F 23/10; B01F 101/00; B01J 8/02

(52) U.S. Cl. CPC B01F 25/4312; B01F 23/10; B01F 25/4315; B01F 25/431972; B01J 8/0278; B01F 2101/2204; B01J 2208/00938

(57) ABSTRACT

An internal gas distributor for a container includes a stagnation plate that provides an impinging surface for gas flowing through a gas inlet of a container. The internal gas distributor further includes a guide vane weir that is disposed of downstream of the stagnation plate. The guide vane weir includes guide vanes disposed on an internal periphery of the first guide vane weir configured to deflect gas to a predefined angular range and slots configured to enable gas to travel in an undeflected manner. Various custom-designed internal gas distributors suited for various containers and/or applications are possible. The internal gas distributor provides a uniform and consistent gas flow for the container.

### TECHNICAL FIELD

The present invention generally relates to gas distributors and more particularly, the present invention relates to an internal gas distributor configured for providing a uniform and consistent gas flow for a container.

### BACKGROUND

Pressure vessels, tanks, and ducting that utilize a catalyst need to have the gas travel through the catalyst at a consistent and uniform velocity. Generally, a high-velocity carrier gas such as but not limited to nitrogen, hydrogen, oxygen, air, and so on is fed from a gas inlet into a catalyzation chamber, also referred to as a “reaction chamber”, “catalytic converter”, “Catalyst Chamber”, “catalyst bed reactor” etc. that is essentially a container having a much larger cross-section than the gas inlet. In theory, the gas velocity through the catalyzation chamber should drop in proportion to the increase in cross-sectional area from the inlet to the chamber. In practice, the gas flowing through the catalyst bed is projected by the inlet nozzle/piping which focuses an increased velocity through the central region with peripheral areas have much lower gas velocity. Thus, the gas flow is unevenly distributed through the catalyst bed along a radial direction. This results in the catalyst toward the center being consumed at a greater rate than catalyst at the periphery. Furthermore, the turbulent nature of the gas flow tends to disintegrate or erode the catalyst. A catalyst bed is made from pellets or honeycomb monolith or porous ceramic or balls or metal screens composed of rare and precious materials such, as but not limited to, Platinum, Rhodium, Palladium, Manganese Dioxide, Cobalt, Zirconium, Vanadium, and so on and thus can represent a very significant cost expense.

Most vessels have no means of distributing the gas resulting in the gas taking the path of least resistance, which typical of the newer high efficiency catalysts and screen style catalyst, is through the center and in line with the inlet piping. Some catalyst vessels use a perforated plate distributor or a perforated tube distributor. These methods employ the path of least resistance and better distribution is attained by wasting energy (also known as a loss in pressure (“pressure drop”)) present in the system. Another common distributor uses a series of stacked rings and a cap plate to redirect the flow radially toward the outside wall which reduces centerline velocity but increases peripheral velocity. Another common distributor traditionally used is a series of discs or wedges hung in the gas stream that uses the pyramid effect to distribute the gas. Another commonly used distributor is in the form of vanes arranged either in a circular pattern or in a linear pattern to direct the gas. Another common method for distributing the gas in a container/vessel is to distance the equipment to allow a large air space in the inlet to the vessel area, and if that air space is large enough the gas will naturally equalize velocity. Another commonly used method for distributing the gas in containers is the use of screens or mesh pads, this is similar to the perforated plate method but utilizes a series of screens or mesh pads to allow the distance method to require a smaller distance. Another known method is the use of porous media like a demisting pad or mesh of woven or looped metal wire or a ceramic sponge-like material which is in essence a path of least resistance method.

All of the above distribution methods have their disadvantages. The path of least resistance causes energy loss with the system requiring more energy to maintain production rates. The perforated capped tube and capped stacked disc methods send high-velocity streams of gas radially outward which impinges on the outside edge of the catalyst and can damage the catalyst by displacing the catalyst and causing them to rub against each other, which creates dust particles that can plug the catalyst bed. The perforated plates are similar to a shower head where the perforated plates accelerate the flow through a series of perforations, acting like small nozzles that spread high-velocity jets over a larger arca. Although this spreads distribution over a larger area, the jets are still focused impingement points that create pockets of higher and lower velocity.

Various other solutions do exist in the prior art. For instance, CN201826012U discloses a gas distributor for uniformly discharging gas, which is normally arranged on the intake section of a chemical vapor deposition apparatus and used for providing uniform gas for a reaction chamber. The gas distributor comprises at least one intake tube and more than two closed gas distribution chambers, which are communicated with one another and sequentially and firmly connected along the moving direction of gas flow, each two neighbouring gas distribution chambers are partitioned from each other by a connecting wall with more than one gas distribution hole distributed on the surface of each connecting wall. By adjusting the height or length of each gas distribution chamber and the arrangement positions and aperture of the gas distribution holes on the surface of each connecting wall, the utility model can ensure that the final flow velocity of discharged gas is uniform.

The existing solutions related to gas distributors are either ineffective or inefficient or both due to design flaws leading to high energy loss. In light of the foregoing, there is a need for an internal gas distributor that provides a uniform and consistent gas flow for the container. Thus, a “stagnation weir” type internal gas distributor is proposed that eliminates the disadvantages of the existing prior art.

### SUMMARY

It is an objective of the present invention to provide an internal gas distributor that provides a uniform and consistent gas flow for containers.

It is an objective of the present invention to provide an internal gas distributor that reduces the high-velocity gas flow areas and increases the low-velocity areas for even distribution in a catalyzation chamber.

It is an objective of the present invention to provide an internal gas distributor that provides even distribution while minimizing pressure losses

Embodiments of the present invention disclose an internal gas distributor for a container, wherein the internal gas distributor comprises a stagnation plate that provides an impinging surface for gas flowing through a gas inlet of a container, a guide vane weir disposed downstream of the stagnation plate; wherein the guide vane weir includes a plurality of guide vanes disposed on an internal periphery of the guide vane weir; wherein the plurality of guide vanes are configured to deflect gas coming towards the plurality of guide vanes to a predefined angular range; wherein a slot is formed between consecutive guide vanes selected from the plurality of guide vanes, wherein the slot does not deflect gas coming towards the slot.

In another embodiment, the internal gas distributor includes a guiding plate that is configured to direct gas from the stagnation plate toward the guide vane weir.

In another embodiment, a top wall of the container is configured to direct gas from the stagnation plate towards the guide vane weir.

In another embodiment, the weir slot(s) comprises an element selected from a group comprising of: a perforated hole(s), a porous semi-permeable media, and combinations thereof.

In another embodiment, the plurality of guide vanes is configured to deflect gas coming towards the plurality of guide vanes to a predefined angular range that varies from 20 degrees to 180 degrees.

In another embodiment, the weir slot has the shape of at least a triangular cut-out, a circle, an oval, a square, a rectangle, a hexagon, and a pentagon.

In another embodiment, a catalyst bed is positioned downstream of the guide vane weir.

Embodiments of the present invention further disclose an internal gas distributor for a container, wherein the internal gas distributor comprises a bypass gas passage that is fluidly connected to a bypass gas inlet of the container, and a mixer disposed downstream of a gas inlet of the container and the bypass gas passage, and wherein the mixer includes a central plate including a central orifice. A plurality of directional baffles is attached to an outer circumference of the central plate. The mixer further includes a conical element that includes an opening, wherein the mixer is configured to mix the flow of gases coming from the gas inlet and the bypass gas passage. The internal gas distributor further includes a stagnation plate disposed downstream of the mixer, wherein the stagnation plate provides an impinging surface for gas flowing through the mixer; and a guide vane weir disposed downstream of the stagnation plate. The guide vane weir includes a plurality of guide vanes disposed on an internal periphery of the guide vane weir, wherein a slot is formed between consecutive guide vanes selected from the plurality of guide vanes.

In another embodiment, a catalyst bed is positioned downstream of the guide vane weir.

In another embodiment, at least one of a catalyst bed and/or an internal gas distributor is positioned upstream of the internal gas distributor.

In another embodiment, a bypass orifice plate includes a central slot; wherein the bypass orifice plate is configured to direct gas coming from the gas inlet and gas/fuel from the bypass gas passage towards the mixing distributor.

In another embodiment, the bypass gas passage is defined by a connection arrangement of ducts, plates, walls, and/or piping disposed of in either the container and/or the internal gas distributor that is configured to introduce bypass gas and/or fuel coming from the bypass gas inlet to the internal gas distributor.

Embodiments of the present invention further disclose an internal gas distributor for a container comprising a conical frustum shaped element that includes a large hole (a first hole) configured to provide passage for gas coming from a gas inlet of the container; a small hole (second hole) positioned downstream from the large hole; an inner conical frustum surface for fluidic communication between the large hole and the small hole; and an outer conical frustum surface disposed opposite of the inner conical frustum surface. The gas distributor further includes a striking plate positioned downstream of the conical frustum-shaped element, wherein the striking plate includes a plurality of directional baffles. The gas distributor further includes a fluid channel positioned downstream of the striking plate; wherein the fluid channel is configured to direct gas flow from the striking plate towards the outer conical frustum surface of the conical frustum-shaped element; and further redirect the gas flow from the outer conical frustum surface of the conical frustum shaped element to a central orifice of an orifice plate. The gas distributor further comprises a stagnation plate positioned downstream of the orifice plate, wherein the stagnation plate provides an impinging surface for gas flowing through a central orifice; and a guide vane weir disposed downstream of the stagnation plate. The guide vane weir includes a plurality of guide vanes disposed on an internal periphery of the guide vane weir; wherein a slot is formed between consecutive guide vanes selected from the plurality of guide vanes.

In another embodiment, the striking plate includes a plurality of directional baffles that are interconnected in the form of a spiral pattern.

In another embodiment, the fluid channel is defined by the connection arrangement of ducts, plates, walls, and/or piping disposed of in either the container and/or the internal gas distributor that is configured to direct the gas flow from the striking plate to a central orifice of an orifice plate through the conical frustum shaped element.

In another embodiment, a catalyst bed is positioned downstream of the internal gas distributor.

The present invention provides an internal gas distributor. These and other features and advantages of the present invention will become apparent from the detailed description below, in light of the accompanying drawings

### BRIEF DESCRIPTION OF THE DRAWINGS

In drawings:

FIG. 1 illustrates a front-sectional view of an internal gas distributor, according to an embodiment of the invention.

FIG. 2 illustrates a schematic flow diagram of an internal gas distributor of the present invention installed inside a container, according to another embodiment of the invention.

FIG. 3 illustrates a sectional perspective view of the internal gas distributor of FIG. 2 installed in a container.

FIG. 4 illustrates a front perspective view of the internal gas distributor of FIG. 2.

FIG. 5 illustrates a sectional front perspective view of the internal gas distributor taken along dashed lines A-A of FIG. 4.

FIG. 6 illustrates a front view of the internal gas distributor of FIG. 2.

FIG. 7 illustrates a sectional front view of the internal gas distributor taken along dashed lines B-B of FIG. 6.

FIG. 8 illustrates a schematic flow diagram of an internal gas distributor installed in a container, according to yet another embodiment of the invention.

FIG. 9 illustrates a front perspective view of the internal gas distributor of FIG. 8.

FIG. 10 illustrates a sectional front perspective view of the internal gas distributor taken along dashed lines C-C of FIG. 9.

FIG. 11 illustrates a front view of the internal gas distributor of FIG. 8.

FIG. 12 illustrates a sectional front view of the internal gas distributor taken along dashed lines D-D of FIG. 11.

### DETAILED DESCRIPTION

Before describing the present invention in detail, it should be observed that the present invention utilizes a combination of components or processes, which constitutes an internal gas distributor. Accordingly, the components or processes have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the invention, which can be embodied in various forms. Therefore, specific component-level details and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

References to “one embodiment”, “an embodiment”, “another embodiment”, “one example”, “an example”, “another example” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment. The words “comprising”, “having”, “containing”, and “including”, and other forms thereof, are intended to be equivalent in meaning and be open-ended in that an item or items following any one of these words is not meant to be an exhaustive listing of such item or items or meant to be limited to only the listed item or items.

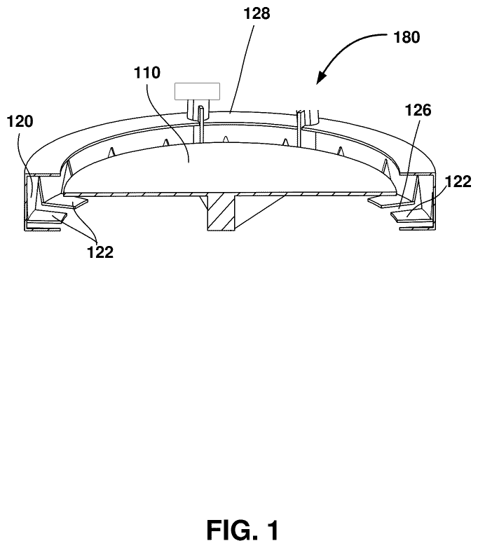

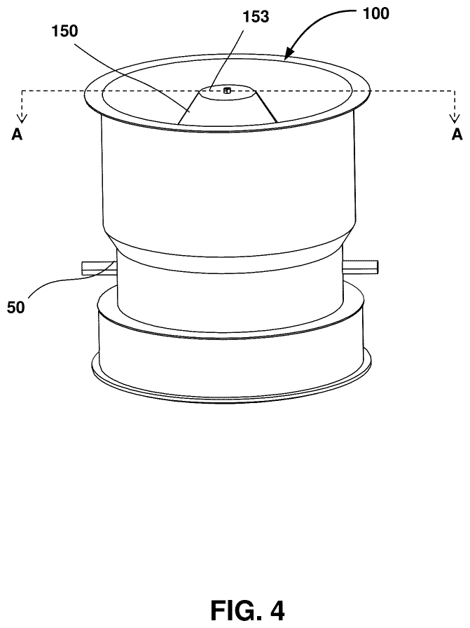

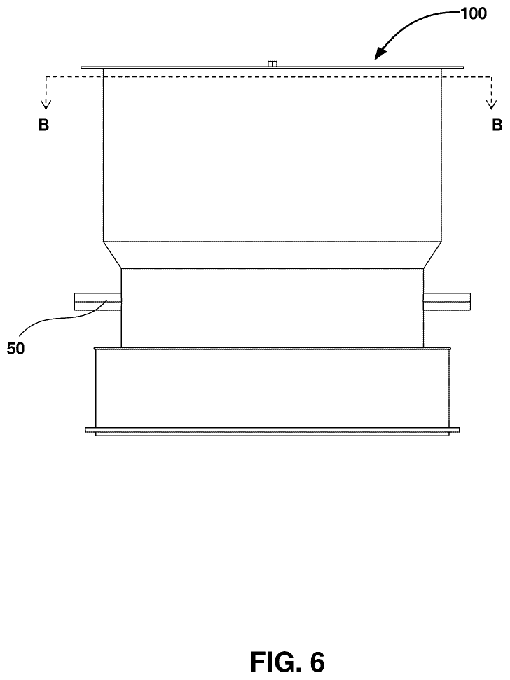

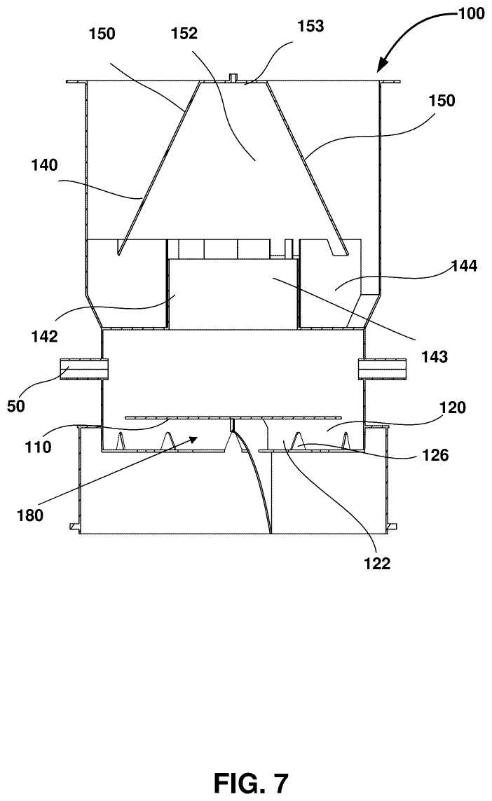

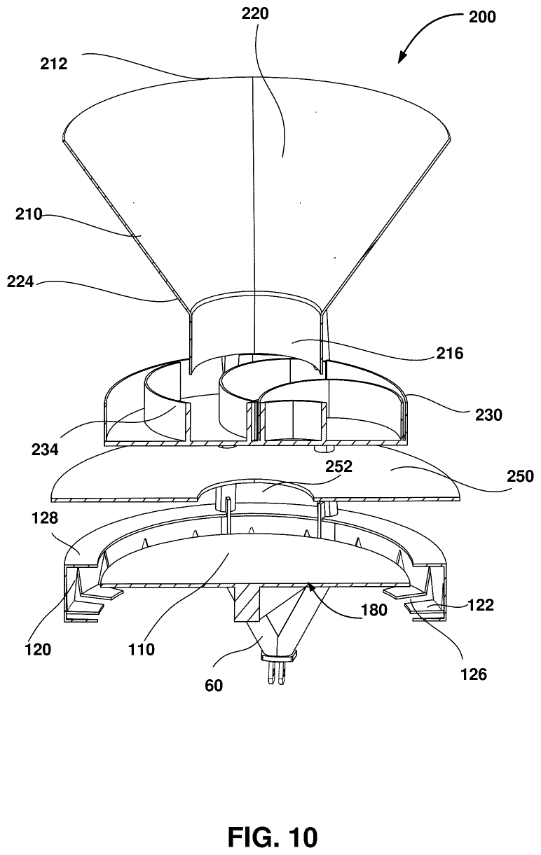

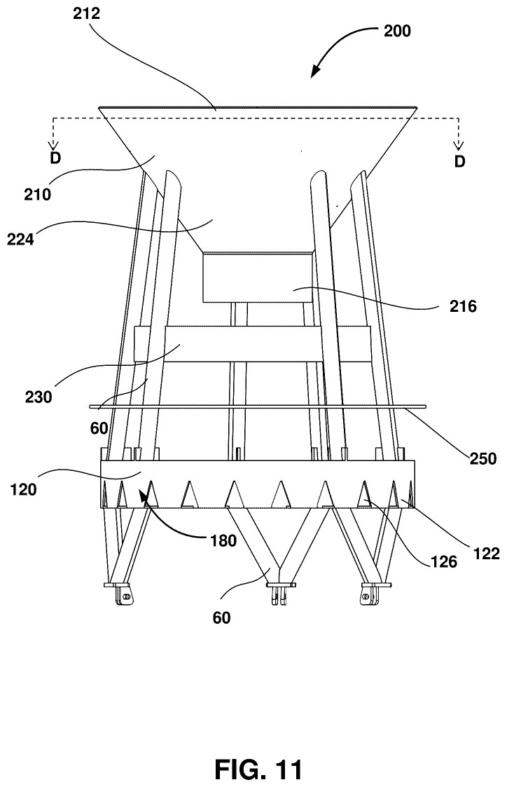

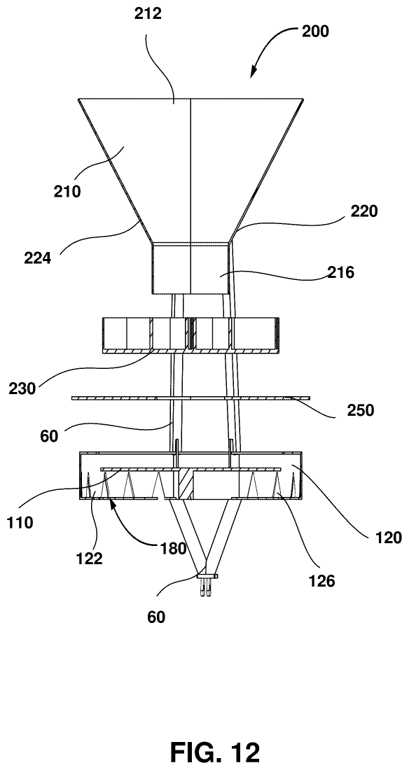

The internal gas distributor of various embodiments of the present invention will now be described with reference to the accompanying drawings, particularly FIGS. 1-12.

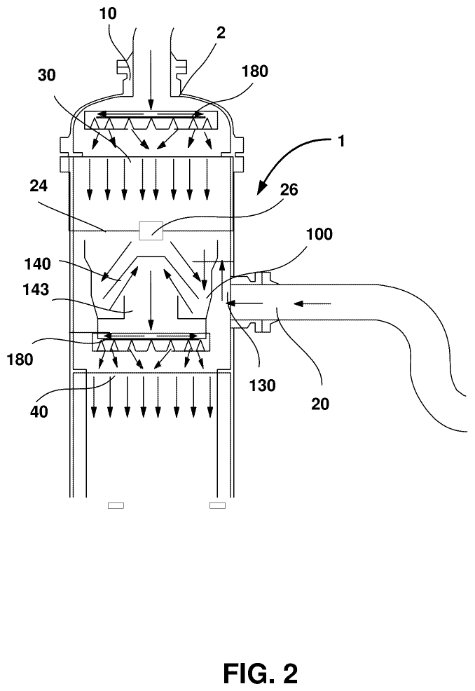

FIG. 1 illustrates a front-sectional view of an internal gas distributor 180, according to an embodiment of the invention. The internal gas distributor 180 provides a uniform and consistent gas flow and the internal gas distributor 180 is configured to be installed in a container 1 (FIG. 2) including but not limited to pressure vessels, tanks, catalyst chamber, ducting, and so on. The internal gas distributor 180 is also referred to as a “stagnation weir distributor”. The internal gas distributor 180 comprises a stagnation plate 110 and a guide vane weir 120. The stagnation plate 110 provides an impinging surface for any incoming gas flowing through a gas inlet 10 of the container 1 (FIG. 2). The stagnation plate 110 is essentially a disc placed substantially perpendicular to the flow of incoming gas and the stagnation plate 110 stops at least the majority of the gas momentum and forces the gas radially outward toward the guide vane weir 120 at a reduced velocity. The guide vane weir 120 is disposed of downstream of the first stagnation plate 110. The guide vane weir 120 includes a plurality of guide vanes 122 disposed on an internal periphery of the first guide vane weir 120. The guide vanes 122 are configured to change the angle of gas coming towards the plurality of guide vanes 122 to a predefined angular range. The angular range may vary from 20 degrees to 180 degrees according to an embodiment. Further, a slot or weir slot 126 is formed between consecutive guide vanes 122 of guide vanes 122. The slot(s) 126 does not change the angle of gas coming towards the weir slot 126. The arrangement of the slots 126 and the guide vanes 122 on the inner periphery of the guide vane weir 120 ensures some gas goes outward (straight) in an undeflected manner due to the weir slots 126 and directs some gas inward (towards the center) in deflected manner due to the guide vanes 122 so that the resultant gas going downstream (downwards) is evenly distributed by the guide vane weir 120. The slot(s) 126 may be designed as perforated holes as seen in FIG. 1 or alternatively, the weir slot(s) 126 may include a porous semi-permeable mesh/membrane (not shown in figures) that would allow some portion of gas to pass through.

In an embodiment as seen in FIG. 1, the weir slot(s) 126 is a triangular cut-out. However, it should be understood that the weir slot(s) 126 may have other shapes such as but not limited to: circle, oval, square, rectangle, hexagon, pentagon, and so on.

In an embodiment as seen in FIG. 1, the internal gas distributor 180 includes a guiding plate 128 (FIG. 1) that is configured to direct gas from the stagnation plate 110 towards the guide vane weir 120. In an embodiment as seen in FIG. 2, a top wall 2 of the container 1 is configured to direct gas from the stagnation plate 110 towards the guide vane weir 120. Further, a catalyst bed 30 may be positioned downstream of the guide vane weir 120 ensuring the internal gas distributor 180 provides a uniform and consistent gas flow at a reduced velocity for the catalyst bed 30. The catalyst bed 30 is conventional in design and well known in the art. The catalyst bed 30 may include catalyst(s) such as but not limited to: Platinum, Rhodium, Palladium, Manganese Dioxide, Cobalt, Zirconium, Vanadium, and so on. Further, the catalyst bed 30 can be a heater that elevates reactivity temperature for further chemical reactions downstream of the catalyst bed 30.

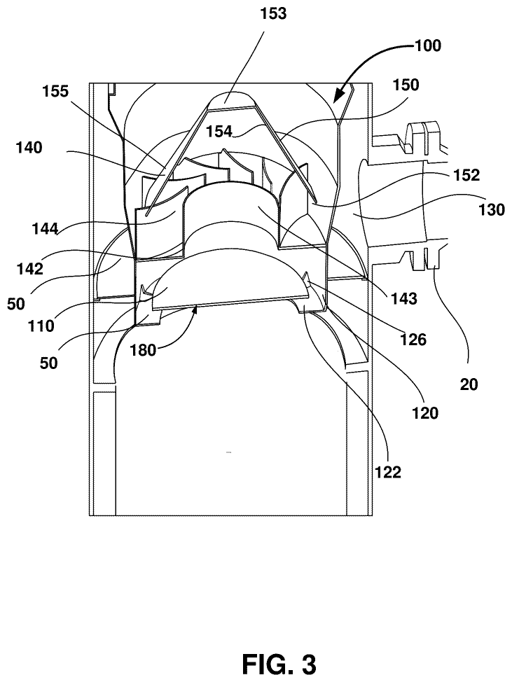

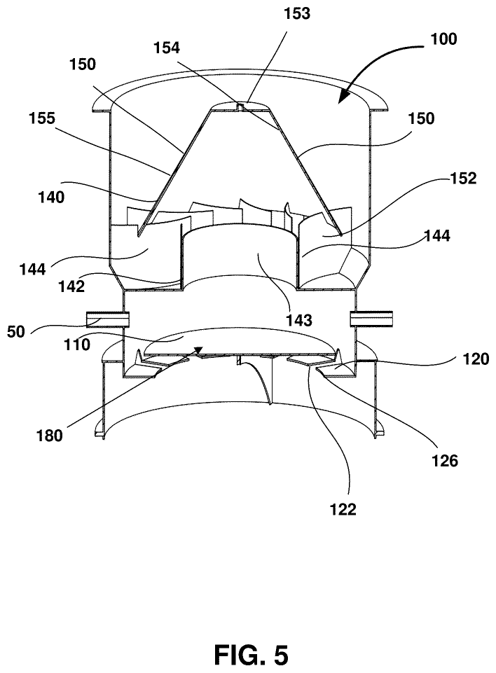

Referring to FIGS. 2-7, the internal gas distributor 100 is shown, according to another embodiment of the present invention. The internal gas distributor 100, also referred to as “Side Bypass Lotus Stagnation Weir Distributor”, is configured to be installed in a container 1 having more than one gas inlet and requires mixing of various gases/fuel and combinations thereof. As seen in FIGS. 2-3, the container 1 includes a gas inlet 10, also referred to herein as primary gas inlet 10, and a bypass gas inlet 20. The internal gas distributor 100 includes a bypass gas passage 130, a mixer 140, and the internal gas distributor 180. The internal gas distributor 180 has been described above with reference to FIG. 1. The bypass gas passage 130 is fluidly connected to a bypass gas inlet 20 of the container 1. The bypass gas passage 130 is defined by a connection arrangement of ducts, plates, walls, and/or piping disposed in either the container 1 and/or the internal gas distributor 100 that are configured to introduce bypass gas and/or fuel coming from the bypass gas inlet 20 to the internal gas distributor 100. The mixer 140 is disposed downstream of gas inlet 10 of the container 1 and the bypass gas passage 130. The mixer 140 includes a central plate 142 having a central orifice 143. A plurality of directional baffles 144 are attached in a substantially radial direction to an outer circumference of the central plate 142 in the form of a pattern as seen in FIG. 3 and FIG. 5. However, in various other embodiments, the directional baffles 144 may be attached to an outer circumference of the central plate 142 in any pattern including but not limited to bicycle wheel (spoke) pattern, spiral pattern, and so on.

The mixer 140 further includes a conical element 150 that includes an opening 152 in the form of a circle and an opposite closed end (vertex) 153. The opposite closed end (vertex) 153 may be semi-flat (FIG. 3) or may have a pointy (sharp) edge. The conical element 150 further includes an inner conical surface 154 and an oppositely disposed outer conical surface 155. The mixer 140 is configured to mix the flow of gases coming from the gas inlet 10 and the bypass gas passage 130. The plurality of directional baffles 144 of the mixer 140 serves the purpose of spinning the gas upstream of the internal gas distributor 180. Further, the mixer 140 extends the distance the gases need to travel in parallel. Providing a spinning functionality to the gases in the mixer 140 increases the streamline path length of the gases which increases mixing and yields high performance results while minimizing energy losses and minimal pressure drop.

As earlier described with reference to FIG. 1 the internal gas distributor 180 includes a stagnation plate 110 disposed downstream of the mixer 140. The stagnation plate 110 provides an impinging surface for gas flowing through the mixer 140. The distributor 180 includes a guide vane weir 120 disposed downstream of the stagnation plate 160. The guide vane weir 120 includes guide vanes 122 disposed on an internal periphery of the guide vane weir 120; wherein a weir slot 126 is formed between consecutive guide vanes 122.

Referring to FIGS. 2-3 and FIGS. 4-7 that illustrate various views of the internal gas distributor 100, gas comes in from the gas inlet 10 through the top wall 2 of the container 1 through an internal gas distributor 180 (described earlier with respect to FIG. 1). FIG. 2 illustrates a schematic flow diagram of the internal gas distributor 100 installed in a container 1 wherein the flow of gas and bypass gas/fuel is represented by pointed arrows. Further, a catalyst bed 30 is positioned downstream of the guide vane weir 120, and the internal gas distributor 180 (the first internal gas distributor 180) provides a uniform and consistent gas flow at a reduced velocity for the catalyst bed 30. Then, the uniform gas at reduced velocity travels down into the internal gas distributor 100 where additional bypass gas/fuel flows in through the bypass gas passage 130 that is fluidly connected to a bypass gas inlet 20 of the container 1. Then the mixture of both gases flows over the outer conical surface 155 of the conical element 150 and then flows down through the directional baffles 144 attached to an outer circumference of the central plate 142. Then afterward, the gas mixture flows over the inner conical surface 154 of the conical element 150 and then flows through the central orifice 143 of the central plate 142. Afterward, the resultant gas mixture travels through another internal gas distributor 180 (a second internal gas distributor 180) described earlier with reference to FIG. 1 and then flows into catalyst bed 40, which is positioned downstream of the second internal gas distributor 180.

In an embodiment as seen in FIG. 2, a bypass orifice plate 24 includes a central slot 26. The central slot 26 of the bypass orifice plate 24 is configured to direct gas coming from the gas inlet 10 and the gas/fuel from the bypass gas passage 130 towards the mixer 140.

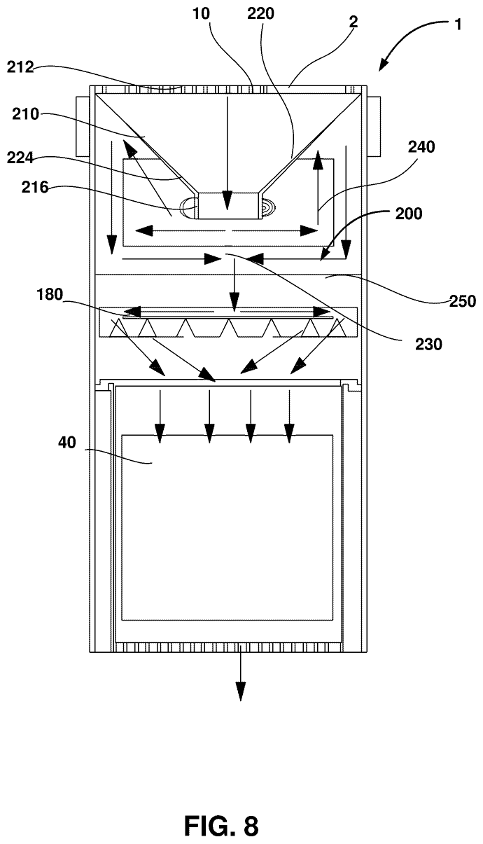

FIG. 8 illustrates a schematic flow diagram of an internal gas distributor 200 installed in a container 10, according to yet another embodiment of the invention. The internal gas distributor 200, also referred to as “lotus orifice stagnation weir distributor” comprises a conical frustum-shaped element 210, a striking plate 230, a fluid channel 240, an orifice plate 250, and the internal gas distributor 180 wherein the internal gas distributor 180 is described above with reference to FIG. 1.

Referring to FIGS. 8-12, the conical frustum-shaped element 210 includes a substantially larger hole 212 (a large hole 212) that is configured to provide passage for gas coming from a gas inlet 10 of the container 1, a substantially smaller hole 216 (a small hole 216) positioned downstream of the large hole 212, an inner conical frustum surface 220 for fluidic communication between the large hole 212 and the small hole 216, and an outer conical frustum surface 224 disposed opposite of the inner conical frustum surface 220. The terms “large” and “small” are used as terms to differentiate the sizes of the holes 212,216 and purely to compare the two holes 212,216, and have their general meaning as will be understood by a person skilled in the art.

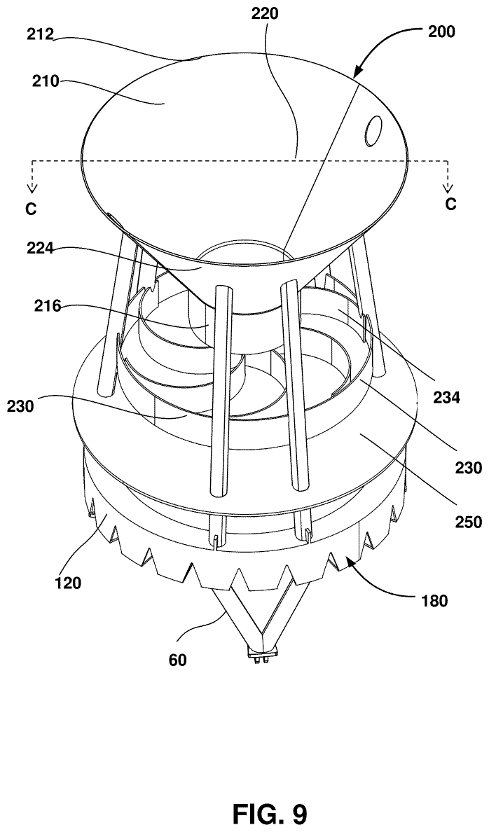

The striking plate 230 is positioned downstream of the conical frustum shaped element 210. The striking plate 230 includes directional baffles 234 that are interconnected in the form of a spiral pattern as seen in FIG. 9. However, in various other embodiments, the directional baffles 234 may be interconnected to form any pattern including but not limited to bicycle wheel (spoke) pattern and so on. The fluid channel 240 is positioned downstream of the striking plate 230. The fluid channel 240 is configured to direct gas flow from the striking plate 230 towards the outer conical frustum surface 224 of the conical frustum-shaped element 210; and further, redirect the gas flow from the outer conical frustum surface 224 of the conical frustum-shaped element 210 to a central orifice 252 of an orifice plate 250. The fluid channel 240 is formed (defined) by the connection arrangement of ducts, plates, walls, and/or piping disposed in either the container 1 and/or the internal gas distributor 200 that are configured to direct the gas flow from the striking plate 230 to a central orifice 252 of an orifice plate 250 through the conical frustum shaped element 210.

As earlier described with reference to FIG. 1 the internal gas distributor 180 includes a stagnation plate 110 disposed downstream of the orifice plate 250. The stagnation plate 110 provides an impinging surface for gas flowing through the orifice plate 250. The internal gas distributor 180a includes a guide vane weir 120 disposed downstream of the stagnation plate 160. The guide vane weir 120 includes guide vanes 122 disposed on an internal periphery of the guide vane weir 120, and a weir slot 126 is formed between consecutive guide vanes 122 selected from the plurality of guide vanes 122.

Referring to FIGS. 8-12, in operation, gas comes in from the gas inlet 10 through the top wall 2 of the container 1 through the large hole 212, then passes through the inner conical frustum surface 220 to the small hole 216. As seen, FIG. 8 illustrates a schematic flow diagram of the internal gas distributor 200 installed in the container 1 wherein the flow of gas is represented by pointed arrows. Afterward, the gas travels to the directional baffles 234 of the striking plate 230 and then is deflected to the fluid channel 240. The fluid channel 240 directs gas flow from the striking plate 230 towards the outer conical frustum surface 224 of the conical frustum shaped element 210, and further redirects the gas flow from the outer conical frustum surface 224 of the conical frustum shaped element 210 to the central orifice 252 of the orifice plate 250. Next, the gas travels through an internal gas distributor 180 and then flows into an optional catalyst bed 40 positioned downstream of the internal gas distributor 180. The advantage of the internal gas distributor 200 is that the internal gas distributor 200 can utilize the full space of the container 1 and push the gas using the directional baffles 234 of the striking plate 230 (“lotus section”) back up into the outer conical frustum surface 224 where the streamlines are extended before going back down around the striking plate 230 into the internal gas distributor 180.

The internal gas distributor (100, 180, 200) may be attached to the container 1 by various conventional methods/techniques known in the art. The internal gas distributor (100, 180, 200) may be hung from an overhead container flange (not shown in figures) of the container 1. Alternatively, the gas distributor (100, 180, 200) may sit on supporting legs 60 (FIG. 9). Alternatively, the gas distributor (100, 180, 200) may sit on a skirt/shoulder 50 (FIG. 3) of the container 1. Further, it should be understood that the internal gas distributor (100, 180, 200) may be attached to the container 1 by other methods/techniques such as but not limited to: welding, riveting, brazing, soldering, sheet metal joints, cold pressing, and so on. Further, it should be understood that the internal gas distributor (100, 180, 200) may be integrally formed (connected) to the container 1 during manufacturing.

The internal gas distributor (100, 180, 200) are suited for use on various types of containers and/or applications. In an exemplary embodiment, the internal gas distributor 180 (stagnation weir distributor) is suited for use on container 1 having an elliptical head having a controlled gap (small gap) between the top of the internal gas distributor 180 and the underside of the container 1. The internal gas distributor 200 (lotus orifice stagnation weir distributor) is suited for use in cone head container (vessel) 1 or in the lower portion of the container 1 where there is no controlled gap (large gap) between the top of the internal gas distributor 200 and the underside of the container 1 having an elliptical head. The internal gas distributor 100 (side bypass lotus stagnation weir) is suited for use in containers where mixing of various gases/fuels and distribution are required. However, it should be understood that the gas distributor (100, 180, 200) may be interchangeably deployed (used) in any other type of container 1 with little to no variation in functionality. For instance, cither the internal gas distributor 180 (stagnation weir distributor) or the internal gas distributor 200 (orifice stagnation weir distributor) may also be used for applications that require mixing of various gases/fuels and distribution and so on. Similarly, either the internal gas distributor 180 (stagnation weir distributor) or the internal gas distributor 100 (mixing lotus orifice stagnation weir) may also be used for cone head container (vessel) 1 or in the lower portion of a container 1 where there is not a controlled gap (large gap) between the top of the internal gas distributor 200 and the underside of the container 1 having an elliptical head.

The internal gas distributor (100, 180, 200) of various embodiments of the present invention is primarily used for pressure vessels that include a catalyst such as but not limited to: Nitric Acid Gauze Converter Catalyst, low pressure Selective catalytic reduction (SCR) Catalyst, Low Temperature Shift Catalyst, and Secondary Reformer Catalyst and so on. However, it should be obvious to the one skilled in the art that the internal gas distributor (100, 180, 200) may be used for other purposes involving the use of uniform and consistent gas flow that may or may not have catalyst such as but not limited to refinery, power plant, chemical plant, factories, chemical laboratories, nuclear installations, electricity generation and so on. Broadly speaking, the internal gas distributor (100, 180, 200) may be used to serve any purpose related to providing a uniform and consistent gas flow for various applications. Further, the internal gas distributor (100, 180, 200) of various embodiments of the present invention has a substantial cylindrical shape with a circular cross-section. However, it should be understood that the internal gas distributor (100, 180, 200) can have any shape and size depending on the specifications of the container 1.

Although particular embodiments of the invention have been described in detail for purposes of illustration, various modifications, and enhancements may be made without departing from the spirit and scope of the invention.

What is claimed is:

1. An internal gas distributor (180) for a container (1), comprising:
a stagnation plate (110) configured to provide an impinging surface for gas flowing through a gas inlet (10) of a container (1);
a guide vane weir (120) disposed downstream of the stagnation plate (110), the guide vane weir (120) includes a plurality of guide vanes (122) disposed on an internal periphery of the guide vane weir (120), wherein the plurality of guide vanes (122) is configured to deflect gas coming towards the plurality of guide vanes (122) to a predefined angular range; and
a weir slot (126) formed between consecutive guide vanes (122) selected from the plurality of guide vanes (122), wherein the weir slot (126) does not deflect gas coming towards the slot (126).

2. The internal gas distributor (180) according to claim 1 further comprising a guiding plate (128) configured to direct gas from the stagnation plate (110) towards the guide vane weir (120).

3. The internal gas distributor (180) according to claim 1, wherein a top wall (2) of the container (1) is configured to direct gas from the stagnation plate (110) towards the guide vane weir (120).

4. The internal gas distributor (180) according to claim 1, wherein the weir slot(s) (126) comprising an element selected from a group of elements consisting of a perforated hole, a porous semi-permeable mesh, and combinations thereof.

5. The internal gas distributor (180) according to claim 1, wherein the plurality of guide vanes (122) is configured to deflect gas coming towards them to a predefined angular range that varies from 20 degrees to 180 degrees.

6. The internal gas distributor (180) according to claim 1, wherein the weir slot (126) is at least a triangular cut-out in shape, circular in shape, oval in shape, square in shape, rectangular in shape, hexagonal in shape, and pentagonal in shape.

7. The internal gas distributor (180) according to claim 1 further comprising a catalyst bed (30) positioned downstream of the guide vane weir (120).

8. An internal gas distributor (100) for a container (1), the internal gas distributor (100) comprising:
a bypass gas passage (130) that is fluidly connected to a bypass gas inlet (20) of the container (1);
a mixer (140) disposed downstream of a gas inlet (10) of the container (1) and the bypass gas passage (130), wherein the mixer (140) comprising a central plate (142) including a central orifice (143); and a plurality of directional baffles (144) attached to an outer circumference of the central plate (142);
a stagnation plate (110) disposed downstream of the mixer (140), wherein the stagnation plate (110) is configured to provide an impinging surface for gas flowing through the mixer (140);
a guide vane weir (120) disposed downstream of the stagnation plate (160);
wherein the guide vane weir (120) comprises a plurality of guide vanes (122) disposed on an internal periphery of the guide vane weir (120), and a weir slot (126) formed between consecutive guide vanes (122) selected from the plurality of guide vanes (122); and
wherein the mixer (140) further comprises a conical element (150) that includes an opening (152), wherein the mixer (140) is configured to mix the flow of gases coming from the gas inlet (10), and the bypass gas passage (130).

9. The internal gas distributor (100) according to claim 8 further comprising a catalyst bed (40) positioned downstream of the guide vane weir (120).

10. The internal gas distributor (100) according to claim 8, wherein at least one of: a catalyst bed (30) and/or an internal gas distributor (180) is positioned upstream of the internal gas distributor (100).

11. The internal gas distributor (100) according to claim 1 further comprising a bypass orifice plate (24) having a central slot (26), wherein the bypass orifice plate (24) is configured to direct gas coming from the gas inlet (10) and gas/fuel from the bypass gas passage (130) towards the mixer (140).

12. The internal gas distributor (100) according to claim 8, wherein the bypass gas passage (130) is defined by a connection arrangement of ducts, plates, walls, and/or piping disposed of in either the container (1) and/or the internal gas distributor (100) that are configured to introduce bypass gas and/or fuel coming from the bypass gas inlet (20) to the internal gas distributor (100).

13. An internal gas distributor (200) for a container (1), comprising:
a conical frustum shaped element (210) comprising
a larger hole (212) configured to provide passage for gas coming from a gas inlet (10) of the container (1);
a small hole (216) positioned downstream of the large hole (212);
an inner conical frustum surface (220) for fluidic communication between the large hole (212) and the small hole (216); and
an outer conical frustum surface (224) disposed opposite of the inner conical frustum surface (220);
a striking plate (230) positioned downstream of the conical frustum shaped element (210), wherein the striking plate (230) includes a plurality of directional baffles (234);
a fluid channel (240) positioned downstream of the striking plate (230), the fluid channel (240) is configured to direct gas flow from the striking plate (230) towards the outer conical frustum surface (224) of the conical frustum shaped element (210), and further redirect the gas flow from the outer conical frustum surface (224) of the conical frustum shaped element (210) to a central orifice (252) of an orifice plate (250);
a stagnation plate (110) positioned downstream of the orifice plate (250), wherein the stagnation plate (110) provides an impinging surface for gas flowing through a central orifice (252); and
a guide vane weir (120) disposed downstream of the stagnation plate (110);
wherein the guide vane weir (120) includes a plurality of guide vanes (122) disposed on an internal periphery of the guide vane weir (120); wherein a slot (120) is formed between consecutive guide vanes (122) selected from the plurality of guide vanes (122).

14. The internal gas distributor (200) according to claim 13, wherein the striking plate (230) includes a plurality of directional baffles (234) that are interconnected in the form of a spiral pattern.

15. The internal gas distributor (200) according to claim 13, wherein the fluid channel (240) is defined by the connection arrangement of ducts, plates, walls, and/or piping disposed of in either the container (1) and/or the internal gas distributor (200) that are configured to direct the gas flow from the striking plate (230) to a central orifice (252) of an orifice plate (250) through the conical frustum shaped element (210).

16. The internal gas distributor (200) according to claim 13 further comprising a catalyst bed (40) positioned downstream of the internal gas distributor (180).
